(19) United States
(12) Patent Application Publication
(10) Pub. No.: US 2015/0311027 A1
(43) Pub. Date: Oct. 29, 2015

(54) ANODE MODULE AND RAY TUBE APPARATUS

(71) Applicants: Ru Bai Cheng, Wuxi (CN); Anja Fritzler, Röttenbach (DE); Sven Fritzler, Röttenbach (DE); Jürgen Holzinger, Happurg (DE); Mathias Vautrin, Wuxi (CN); Peng Xu, Wuxi (CN)

(72) Inventors: Ru Bai Cheng, Wuxi (CN); Anja Fritzler, Röttenbach (DE); Sven Fritzler, Röttenbach (DE); Jürgen Holzinger, Happurg (DE); Mathias Vautrin, Wuxi (CN); Peng Xu, Wuxi (CN)

(21) Appl. No.: 14/694,716

(22) Filed: Apr. 23, 2015

(30) Foreign Application Priority Data
Apr. 23, 2014 (CN) 201410166853.2
Apr. 23, 2014 (CN) 201420202751.7

(51) Int. Cl. H01J 35/10

(52) U.S. Cl. CPC H01J 35/105; H01J 35/101

(57) ABSTRACT

A miniaturized anode module includes a target, a rotor module, a first rotation shaft, a second rotation shaft, and a heat barrier. The target is used for receiving an electron beam in order to excite a ray. The rotor module is used for driving the target in rotation. The first rotation shaft is coupled to the target. The second rotation shaft is coupled to the first rotation shaft and the rotor module, such that the rotor module drives the first rotation shaft and the target in synchronous rotation by the second rotation shaft. The heat barrier is disposed between the first rotation shaft and the second rotation shaft, and is used to block the transfer of heat generated by the target when exciting the ray to the second rotation shaft through the first rotation shaft.

This application claims the benefit of CN 201420202751.7, filed on Apr. 23, 2014, and CN 201410166853.2, filed on Apr. 23, 2014, which are hereby incorporated by reference in their entirety.

### TECHNICAL FIELD

The present embodiments relate to an anode module and a ray tube apparatus.

### BACKGROUND

A ray tube apparatus may emit rays (e.g., X-rays) to irradiate an object being scanned (e.g., luggage at an airport or human bones, etc.). Generally, a ray tube apparatus uses a cathode module to emit an electron beam to an anode module target, and generates a ray by exciting the anode module target. The ray tube apparatus may thus emit rays to irradiate an object being scanned. The anode module target will generate heat as the anode module target generates rays. Therefore, ray tube apparatuses often use a rotor module to drive the anode module in rotation, to dissipate the heat generated by the anode module target during ray generation, and thereby reduce the anode module temperature.

In practical applications, ray tube apparatuses also have a heat dissipation fin structure, which is made of graphite material and connected to one side of the target. The heat dissipation fin structure is used to dissipate the heat generated by the anode module target when generating rays, in order to further reduce the anode module temperature. However, the heat dissipation fin structure has a definite volume, so the ray tube apparatus is to be of a sufficient volume to house the heat dissipation fin structure used for dissipating heat. Thus, the heat dissipation fin structure places restrictions on the dimensions of the anode module and therefore is not conducive to the application of ray tube apparatus miniaturization.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, a miniaturized anode module and a ray tube apparatus are provided.

A miniaturized anode module suitable for use in a ray tube apparatus is provided. The ray tube apparatus includes a cathode module for emitting an electron beam, and the anode module includes a target, a rotor module, a first rotation shaft, a second rotation shaft and a heat barrier. The target is used for receiving the electron beam in order to excite a ray, the rotor module is used for driving the target in rotation, and the first rotation shaft is coupled to the target. The second rotation shaft is coupled to the first rotation shaft and the rotor module, such that the rotor module drives the first rotation shaft and the target in synchronous rotation by the second rotation shaft. The heat barrier is disposed between the first rotation shaft and the second rotation shaft and used to block the transfer of heat generated by the target when exciting the ray to the second rotation shaft through the first rotation shaft.

According to one embodiment, the first rotation shaft has a first end and a second end opposite the first end. The first end is for coupling to the target. The second rotation shaft has a hub portion, and the anode module further includes a rotor base and a connecting element. The rotor base is joined to the second end, and the connecting element connects the rotor base to the hub portion in order to couple the first rotation shaft to the second rotation shaft.

According to an embodiment, the connecting element is a screw element for locking to the hub portion after passing through the rotor base.

According to an embodiment, the first rotation shaft further has a flange portion disposed between the first end and the second end, and the anode module further includes a press-down element disposed moveably at the first end. The press-down element is for pressing the target down onto the flange portion.

According to an embodiment, the first end is a threaded portion, and the press-down element is a nut that moveably screws onto the threaded portion.

According to an embodiment, the anode module further includes a transmission element that is connected to the target and the flange portion so that the first rotation shaft and the target rotate synchronously.

According to an embodiment, a through-hole is formed in the target, an insertion hole corresponding to the through-hole is formed in the flange portion, the transmission element is an insertion pin, and the press-down element is further used for pressing the insertion pin down to pass through the through-hole and be inserted in the insertion hole.

According to an embodiment, the rotor module includes a rotor housing and multiple bearing elements. The rotor housing is used for enclosing the second rotation shaft. The multiple bearing elements are disposed in the rotor housing and rotatably surround the second rotation shaft.

According to an embodiment, the first rotation shaft, the second rotation shaft, and the heat barrier are arranged coaxially with each other.

According to an embodiment, the heat barrier is made of a material with low thermal conductivity.

According to an embodiment, the heat barrier is made of a ceramic material or alloy material.

According to an embodiment, a ray tube apparatus includes a housing, a cathode module and an anode module. The cathode module is disposed in the housing and is used for emitting an electron beam. The anode module is disposed in the housing. The anode module includes a target, a rotor module, a first rotation shaft, a second rotation shaft and a heat barrier. The target is used for receiving the electron beam in order to excite a ray. The rotor module is used for driving the target in rotation, and the first rotation shaft is coupled to the target. The second rotation shaft is coupled to the first rotation shaft and the rotor module, such that the rotor module drives the first rotation shaft and the target in synchronous rotation by the second rotation shaft. The heat barrier is disposed between the first rotation shaft and the second rotation shaft, and used to block the transfer of heat generated by the target when exciting the ray to the second rotation shaft through the first rotation shaft.

One or more of the present embodiments use the heat barrier to block the transfer of heat generated by the target when irradiated by the electron beam to the second rotation shaft in order to prevent the temperature of the bearing elements from increasing. The service life of the anode module and bearing elements thereof is thus increased. Thus, there is no need to rely on a heat dissipation fin structure to assist in heat dissipation, to reduce the temperature of the anode module during operation. Therefore, the provision of a heat dissipation fin structure may be omitted in the anode module to reduce the volume of the ray tube apparatus. In other words, there is no need for the anode module to be provided with a heat dissipation fin structure for dissipating heat, and this is conducive to the application of miniaturization of the anode module and the ray tube apparatus. The above and other technical content, features and effects of the present embodiments will be clearly shown below in a detailed illustration of embodiments, referring to the accompanying drawings.

### BRIEF DESCRIPTION OF THE DRAWINGS

FIG. 1 is a schematic diagram of the exterior of an embodiment of a ray tube apparatus.

FIG. 2 is an exploded schematic diagram of internal elements of one embodiment of the ray tube apparatus.

FIG. 3 is an exploded schematic diagram of internal elements of one embodiment of the ray tube apparatus, viewed from another angle.

FIG. 4 is a sectional schematic diagram of one embodiment of a ray tube apparatus.

### DETAILED DESCRIPTION

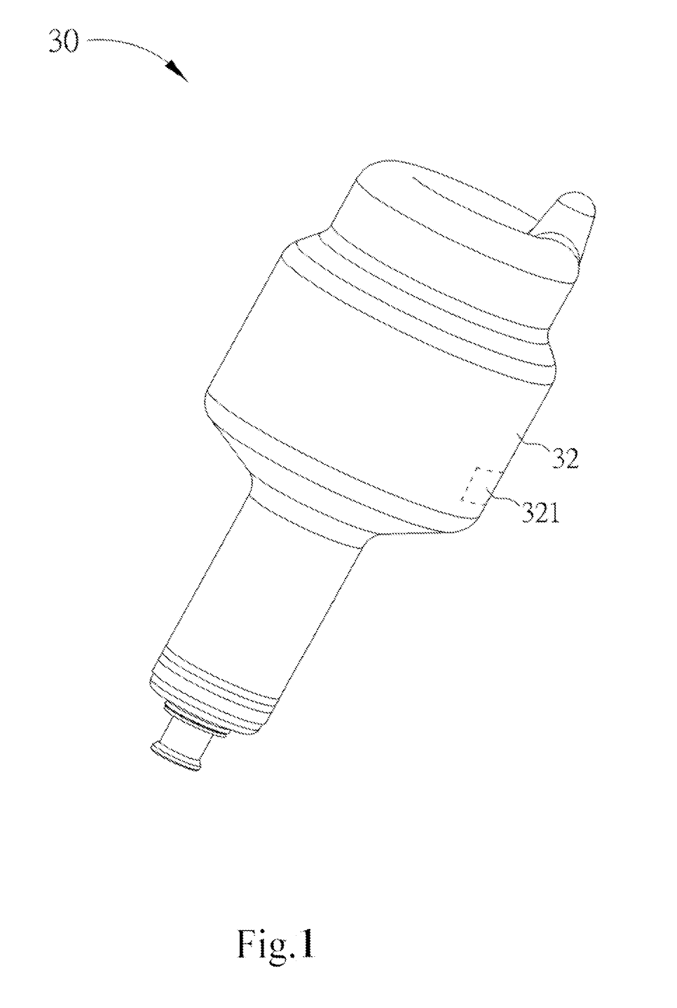

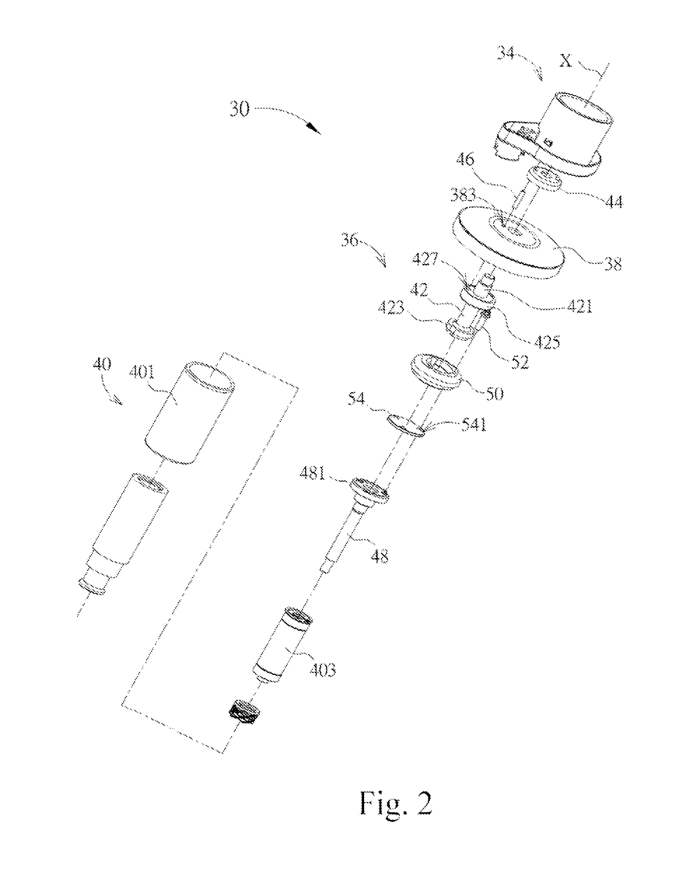

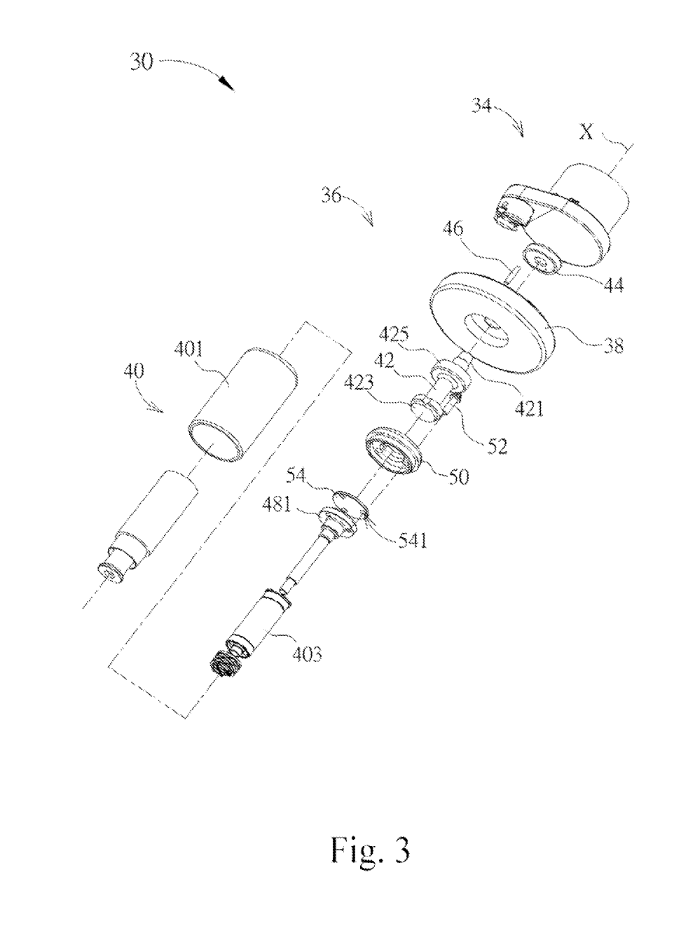

The words used for directions in the following embodiments (e.g., up, down, left, right, front or rear, etc.) merely refer to directions in the accompanying drawings. Thus, the words used for directions serve to illustrate rather than restrict the present invention. FIG. 1 is a schematic diagram of the exterior of a ray tube apparatus 30 in an embodiment, FIG. 2 is an exploded schematic diagram of some internal elements of the ray tube apparatus 30 in an embodiment, and FIG. 3 is an exploded schematic diagram of some internal elements of the ray tube apparatus 30 in an embodiment, viewed from another angle. As FIGS. 1 to 3 show, the ray tube apparatus 30 includes a housing 32 for enclosing and sealing internal elements of the ray tube apparatus 30, so that the internal elements of the ray tube apparatus 30 are in a vacuum state.

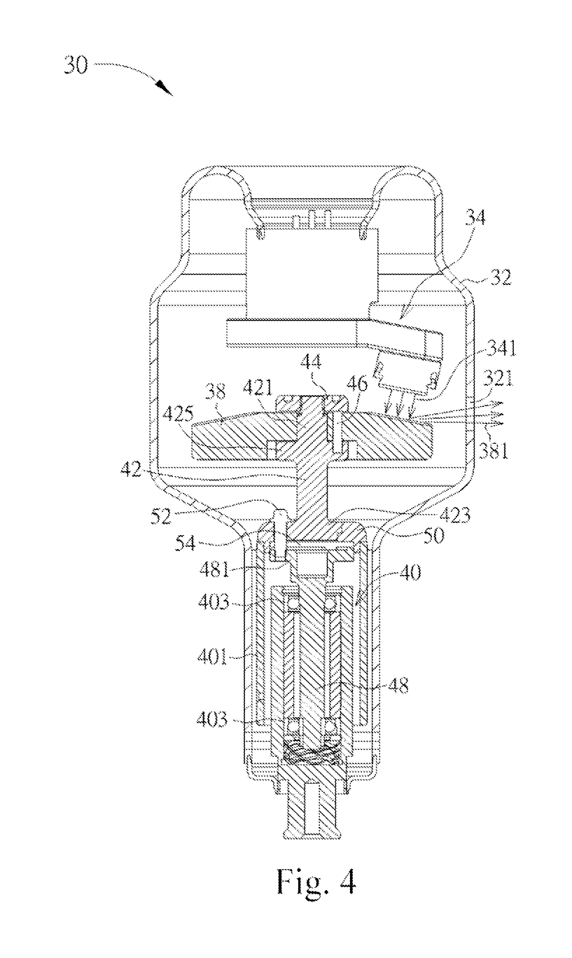

The housing 32 has a transmitting portion 321, and the ray tube apparatus 30 further includes a cathode module 34 and an anode module 36. The cathode module 34 and the anode module 36 are both disposed in the housing 32. FIGS. 2 and 3 omit a drawing of the housing 32 in order to clearly show some of the internal elements of the ray tube apparatus 30. FIG. 4 is a sectional schematic diagram of a ray tube apparatus 30 in an embodiment. As FIGS. 1 to 4 show, the anode module 36 includes a target 38. The cathode module 34 is used for emitting an electron beam 341. The target 38 of the anode module 36 is used for receiving the electron beam 341 in order to excite a ray 381, and the ray 381 may be emitted to the outside of the housing 32 via the transmitting portion 321 in order to irradiate an object to be scanned (e.g., airport luggage or human bones, etc.).

In this embodiment, the target 38 may be made of a titanium zirconium cobalt alloy material (Titanium Zirconium Molybdenum alloy, TZM alloy), with a tungsten rhenium layer (tungsten rhenium coating) being spread over the target 38 made of titanium zirconium cobalt alloy material. The tungsten rhenium layer may be excited to generate X-rays when irradiated by the electron beam 341 (e.g., the ray 381 may be an X-ray). In other words, the ray tube apparatus 30 may be an X-ray tube apparatus. In addition, the anode module 36 further includes a rotor module 40. The target 38 of the anode module 36 will generate heat as the ray 381 is excited, and the rotor module 40 may be used to drive the target 38 of the anode module 36 in rotation, so that the electron beam 341 irradiates the entire target 38 uniformly.

As FIGS. 2 to 4 show, the anode module 36 further includes a first rotation shaft 42 that has a first end 421, a second end 423 and a flange portion 425. The second end 423 is opposite the first end 421, and the flange portion 425 is disposed between the first end 421 and second end 423. In addition, the anode module 36 further includes a press-down element 44 that is moveably disposed at the first end 421 of the first rotation shaft 42. In this embodiment, the first end 421 may be a threaded portion, and the press-down element 44 may be a nut that moveably screws onto the threaded portion, so that the first end 421 (e.g., the threaded portion) is coupled to the target 38. The first rotation shaft 42 may thus be coupled to the target 38. When the press-down element 44 (e.g., the nut) is screwed tightly to the first end 421 (e.g., the threaded portion), the press-down element 44 may press the target 38 down onto the flange portion 425 of the first rotation shaft 42. In this way, the target 38 may be fixed to the first rotation shaft 42.

In addition, the anode module 36 further includes a transmission element 46 that is connected to the target 38 and the flange portion 425 of the first rotation shaft 42 (as FIG. 4 shows). In this embodiment, a through-hole 383 may be formed in the target 38, an insertion hole 427 corresponding to the through-hole 383 may be formed in the flange portion 425 (as FIG. 2 shows), and the transmission element 46 may be an insertion pin. When the press-down element 44 (e.g., the nut) is screwed tightly to the first end 421 (e.g., the threaded portion), the press-down element 44 may further be used for pressing the insertion pin (e.g., transmission element 46) down so as to pass through the through-hole 383 and be inserted into the insertion hole 427. In this way, the transmission element 46 may link the target 38 to the first rotation shaft 42, so that the first rotation shaft 42 and target 38 rotate synchronously. In practical applications, the insertion pin (e.g., transmission element 46) may pass through the through-hole 383 and be inserted in the insertion hole 427 in an interference fit, but the present embodiments are not subject to such a limitation.

As FIGS. 2 to 4 show, the anode module 36 further includes a second rotation shaft 48 and a rotor base 50. The second rotation shaft 48 has a hub portion 481, and the rotor base 50 is joined with the second end 423 of the first rotation shaft 42. In this embodiment, the rotor base 50 may be formed integrally with the first rotation shaft 42 by insert molding, but the present embodiments are not subject to such a limitation. In addition, the anode module 36 further includes a connecting element 52 used for connecting the rotor base 50 to the hub portion 481 of the second rotation shaft 48. In this embodiment, the connecting element 52 may be a screw element, which is locked to the hub portion 481 of the second rotation shaft 48 after passing through the rotor base 50, to connect the second end 423 of the first rotation shaft 42 to the hub portion 481 of the second rotation shaft 48. The second rotation shaft 48 may thus be coupled to the first rotation shaft 42.

In addition, the rotor module 40 includes a rotor housing 401 and multiple bearing elements 403. The rotor housing 401 is used to enclose the second rotation shaft 48. The multiple bearing elements 403 are disposed in the rotor housing 401 and rotatably surround the second rotation shaft 48, so that the second rotation shaft 48 may further be coupled to the rotor module 40 in a rotatable manner. Thus, the anode module 36 of one or more of the present embodiments uses the connecting element 52 to couple the second rotation shaft 48 to the first rotation shaft 42. The anode module 36 also uses the transmission element 46 to link the first rotation shaft 42 to the target 38, so that when the rotor module 40 is running, the rotor module 40 may drive the second rotation shaft 48 in rotation. Using the second rotation shaft 48, the rotor module 40 may drive the first rotation shaft 42 and the target 38 in synchronous rotation, so that the electron beam 341 irradiates the entire target 38 uniformly.

As FIGS. 2 to 4 show, the anode module 36 further includes a heat barrier 54 disposed between the first rotation shaft 42 and the second rotation shaft 48. In this embodiment, a set of assembly holes 541 may be formed in the heat barrier 54 (as FIGS. 2 and 3 show) for connecting elements 52 to pass through, such that the connecting elements 52 are locked to the hub portion 481 of the second rotation shaft 48. The rotor base 50 and the hub portion 481 of the second rotation shaft 48 may abut two opposite sides of the heat barrier 54 (as FIG. 4 shows). When the target 38 of the anode module 36 is exciting rays 381, the heat barrier 54 may be used to block the transfer of heat generated by the target 38 of the anode module 36 when exciting rays 381 to the second rotation shaft 48 and rotor module 40 through the first rotation shaft 42. Thus, the heat barrier 54 may prevent the bearing elements 403 from being heated by heat generated by the target 38 of the anode module 36 when irradiated by the electron beam 341, to prevent the temperature of the bearing elements 403 from increasing, and thus increase the service life of the anode module 36 and bearing elements 403 thereof. In practical applications, since the heat barrier 54 may block the transfer of heat in order to prevent the temperature of the bearing elements 403 from increasing, the ray tube apparatus 30 of one or more of the present embodiments is suitable for use with continuous large currents. This helps to increase the application flexibility of the ray tube apparatus 30.

Thus, one or more of the present embodiments use the heat barrier 54 to block the transfer of heat generated by the target 38 when irradiated by the electron beam 341 to the second rotation shaft 48, in order to prevent the temperature of the bearing elements 403 from increasing, and thus increase the service life of the anode module 36 and bearing elements 403 thereof. Thus, in one or more of the present embodiments, there is no need to rely on a heat dissipation fin structure to assist in heat dissipation, to reduce the temperature of the anode module 36 during operation. Therefore, the provision of a heat dissipation fin structure may be omitted in the anode module 36 of the present embodiments, to reduce the volume of the ray tube apparatus 30. In other words, there is no need for the anode module 36 of one or more of the present embodiments to be provided with a heat dissipation fin structure for dissipating heat, and this is conducive to the application of miniaturization of the anode module 36 and ray tube apparatus 30.

Since the heat barrier 54 may block the transfer of heat generated by the target 38 when irradiated by the electron beam 341 to the second rotation shaft 48, the heat generated by the target 38 when irradiated by the electron beam 341 will accumulate on the target 38, causing the temperature of the target 38 to increase. Also, a heat dissipation fin structure may be made of graphite material, and brass material is to be used to connect such a heat dissipation fin structure made of graphite material to the target 38 made of titanium zirconium cobalt alloy material. Brass material, however, has a low melting point and may not withstand the high temperature of the target 38 during operation. Therefore, taking into account the melting point of this material, the brass material may present an obstacle to the provision of a heat dissipation fin structure on the target 38 of the anode module 36. In practical applications, the target 38 may be a single piece made of titanium zirconium cobalt alloy material, and since the single piece of the target 38 is made completely of titanium zirconium cobalt alloy material, the target 38 may tolerate a higher temperature.

Apart from the above, since the heat generated by the target 38 when exciting rays 381 will accumulate on the target 38, the temperature of the target 38 of the anode module 36 of one or more of the present embodiments will increase significantly during use. A higher temperature is more conducive to heat dissipation by radiation. In other words, the heat barrier 54 of one or more of the present embodiments will prevent the heat generated by the target 38 when exciting rays 381 from being conducted through the second rotation shaft 48 and thereby dissipated, so that the temperature of the target 38 will significantly increase during use, helping the target 38 itself to dissipate heat by radiation.

As FIGS. 2 to 4 show, the first rotation shaft 42, the second rotation shaft 48, and the heat barrier 54 of one or more of the present embodiments are arranged coaxially with each other (e.g., the first rotation shaft 42, the second rotation shaft 48, and the heat barrier 54 are located on an assembly axis X as shown in FIGS. 2 and 3). Therefore, when the rotor module 40 drives the second rotation shaft 48 in rotation, and the rotor module 40 drives the first rotation shaft 42 and the target 38 in synchronous rotation by the second rotation shaft 48, the structural design, whereby the first rotation shaft 42, the second rotation shaft 48 and the heat barrier 54 are arranged coaxially, may reduce the centrifugal force of the heat barrier 54 relative to the first rotation shaft 42 and the second rotation shaft 48. This helps to reduce vibration and abrasion amongst the first rotation shaft 42, the second rotation shaft 48, and the heat barrier 54, and hence increases the reliability and service life of the ray tube apparatus 30 and the anode module 36 thereof.

In this embodiment, the heat barrier 54 can be made of a material with low thermal conductivity, for example the heat barrier 54 may be made of a ceramic material. The heat conduction coefficients of ceramic materials suitable for use as the heat barrier 54 of one or more of the present embodiments, and temperatures capable of being withstood thereby, are listed in Table 1 below:

TABLE 1

| | | | Temp. capable |
|---|---|---|---|
| | Heat conduction | | of being |
| | coefficient | | withstood |
| Ceramic material | 1.4 | W/mK @ 200° C. | 1350° C. |
| (Sillimantin) | | | |
| Aluminum silicate | 1.26 | W/mK @ 300° C. | 1150° C. |
| (M120F) | | | |
| Aluminum titanate | 2 | W/mK @ 100° C. | 900° C. |
| Chromium dioxide | Max. 2 | W/mK @ 100° C. | 1350° C. |
| (C530/Sipalox) | | | |

The heat barrier 54 need not be limited to the abovementioned ceramic materials. For example, the heat barrier 54 may also be made of an alloy material (e.g., a chromium nickel iron material). The heat conduction coefficients of alloy materials suitable for use as the heat barrier 54 of one or more of the present embodiments, and temperatures capable of being withstood thereby, are listed in Table 2 below:

TABLE 2

| | | Temp. capable |
|---|---|---|
| | | of being |
| | Heat conduction coefficient | withstood |
| Cr/Ni/Fe material | 10.8 W/mK @ 100° C. | about 800° C. |
| (Inconel 625) | | |
| Cr/Ni/Fe material | 15 W/mK @ 100° C. | about 1000° C. |
| (Inconel 321) | | |
| Cr/Ni/Fe material | 12 W/mK @ 100° C. | about 1300° C. |
| (Inconel 1.4841) | | |

Compared to the prior art, the present embodiments use the heat barrier to block the transfer of heat generated by the target when irradiated by the electron beam to the second rotation shaft, in order to prevent the temperature of the bearing elements from increasing, and thus increase the service life of the anode module and bearing elements thereof. Thus, in one or more of the present embodiments, there is no need to rely on a heat dissipation fin structure to assist in heat dissipation, to reduce the temperature of the anode module during operation. Therefore, the provision of a heat dissipation fin structure may be omitted in the anode module to reduce the volume of the ray tube apparatus. In other words, there is no need for the anode module to be provided with a heat dissipation fin structure for dissipating heat, and this is conducive to the application of miniaturization of the anode module and ray tube apparatus.

The above embodiments are not intended to limit the invention. To those skilled in the art, various alterations and changes to the present invention are possible. Any amendments, equivalent substitutions or improvements made within the spirit and principles of the present invention are to be included in the scope of protection of the invention.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. An anode module suitable for use in a ray tube apparatus, the ray tube apparatus comprising a cathode module for emitting an electron beam, the anode module comprising:
a target operable to receive the electron beam in order to excite a ray;
a rotor module operable to drive the target in rotation;
a first rotation shaft coupled to the target;
a second rotation shaft coupled to the first rotation shaft and the rotor module, such that the rotor module drives the first rotation shaft and the target in synchronous rotation by the second rotation shaft; and
a heat barrier that is disposed between the first rotation shaft and the second rotation shaft, and used to block transfer of heat generated by the target when exciting the ray to the second rotation shaft through the first rotation shaft.

2. The anode module of claim 1, wherein the first rotation shaft has a first end and a second end opposite the first end, the first end being for coupling to the target, the second rotation shaft having a hub portion, and
wherein the anode module further comprises:
a rotor base joined to the second end; and
a connecting element connecting the rotor base to the hub portion, in order to couple the first rotation shaft to the second rotation shaft.

3. The anode module of claim 2, wherein the connecting element is a screw element lockable to the hub portion after passing through the rotor base.

4. The anode module of claim 2, wherein the first rotation shaft further has a flange portion disposed between the first end and the second end, and
wherein the anode module further comprises:
a press-down element disposed moveably at the first end, the press-down element operable to press the target down onto the flange portion.

5. The anode module of claim 4, wherein the first end is a threaded portion, and the press-down element is a nut that moveably screws onto the threaded portion.

6. The anode module of claim 4, wherein the anode module further comprises:
a transmission element that is connected to the target and the flange portion so that the first rotation shaft and the target rotate synchronously.

7. The anode module of claim 6, wherein a through-hole is formed in the target, an insertion hole corresponding to the through-hole is formed in the flange portion, the transmission element is an insertion pin, and the press-down element is operable to press the insertion pin down to pass through the through-hole and be inserted in the insertion hole.

8. The anode module of claim 1, wherein the rotor module comprises:
a rotor housing for enclosing the second rotation shaft; and
multiple bearing elements that are disposed in the rotor housing and rotatably surround the second rotation shaft.

9. The anode module of claim 1, wherein the first rotation shaft, the second rotation shaft, and the heat barrier are arranged coaxially with each other.

10. The anode module as claimed in claim 1, wherein the heat barrier is made of a material with low thermal conductivity.

11. The anode module of claim 10, wherein the heat barrier is made of a ceramic material or alloy material.

12. A ray tube apparatus comprising:
a housing;
a cathode module that is disposed in the housing and is operable to emit an electron beam; and
an anode module comprising:
a target operable to receive the electron beam in order to excite a ray;
a rotor module operable to drive the target in rotation;
a first rotation shaft coupled to the target;
a second rotation shaft coupled to the first rotation shaft and the rotor module, such that the rotor module drives the first rotation shaft and the target in synchronous rotation by the second rotation shaft; and
a heat barrier that is disposed between the first rotation shaft and the second rotation shaft, and used to block transfer of heat generated by the target when exciting the ray to the second rotation shaft through the first rotation shaft.

13. The ray tube apparatus of claim 12, wherein the first rotation shaft has a first end and a second end opposite the first end, the first end being for coupling to the target, the second rotation shaft having a hub portion, and
wherein the anode module further comprises:
a rotor base joined to the second end; and
a connecting element connecting the rotor base to the hub portion, in order to couple the first rotation shaft to the second rotation shaft.

14. The ray tube apparatus of claim 13, wherein the connecting element is a screw element lockable to the hub portion after passing through the rotor base.

15. The ray tube apparatus of claim 13, wherein the first rotation shaft further has a flange portion disposed between the first end and the second end, and
wherein the anode module further comprises:
a press-down element disposed moveably at the first end, the press-down element operable to press the target down onto the flange portion.

16. The ray tube apparatus of claim 15, wherein the first end is a threaded portion, and the press-down element is a nut that moveably screws onto the threaded portion.

17. The ray tube apparatus of claim 15, wherein the anode module further comprises:
a transmission element that is connected to the target and the flange portion so that the first rotation shaft and the target rotate synchronously.

18. The ray tube apparatus of claim 17, wherein a through-hole is formed in the target, an insertion hole corresponding to the through-hole is formed in the flange portion, the transmission element is an insertion pin, and the press-down element is operable to press the insertion pin down to pass through the through-hole and be inserted in the insertion hole.
